(19) United States
(12) Patent Application Publication
(10) Pub. No.: US 2014/0298157 A1
(43) Pub. Date: Oct. 2, 2014

(54) APPARATUS AND METHOD FOR PRESENTING HTML PAGE

(71) Applicant: Samsung Electronics Co., LTD, Suwon-si (KR)

(72) Inventors: Youngkwon Lim, Allen, TX (US); Imed Bouazizi, Plano, TX (US)

(73) Assignee: Samsung Electronics Co., LTD, Suwon-si (KR)

(21) Appl. No.: 14/179,302

(22) Filed: Feb. 12, 2014

Related U.S. Application Data
(60) Provisional application No. 61/805,394, filed on Mar. 26, 2013.
(60) Provisional application No. 61/805,416, filed on Mar. 26, 2013.

(51) Int. Cl. G06F 17/22

(52) U.S. Cl. CPC G06F 17/2247
USPC 715/234

(57) ABSTRACT

A method for presenting a HTML page comprises determining whether a HTML file contains a reference to a CI document, fetching and processing the CI document describing a behavior of at least one HTML element, and presenting the HTML page by decoding the HTML file, based on the CI document. An apparatus for presenting a HTML page, comprises a processing circuitry configured to determine whether a HTML file contains a reference to a CI document, fetch and process the CI document describing a behavior of at least one HTML element, present the HTML page by decoding the HTML file, based on the CI document.

### CROSS-REFERENCE TO RELATED DISCLOSURE(S) AND CLAIM OF PRIORITY

The present disclosure claims priority to U.S. Provisional Patent Disclosure Ser. No. 61/805,394, filed Mar. 26, 2013, entitled “METHODS AND APPARATUS OF DESCRIBING′TEMPORAL BEHAVIOR OF MEDIA ELEMENTS OF HTML5” and to U.S. Provisional Patent Disclosure Ser. No. 61/805,416, filed Mar. 26, 2013, entitled “COMPOSITION INFORMATION AND HTML 5”. The content of the above-identified patent documents is incorporated herein by reference.

### TECHNICAL FIELD

The present disclosure relates generally to an apparatus and method for presenting a composite HyperText-Markup-Language (HTML) page, and more specifically, to describe temporal behavior of elements and multimedia components in an HTML5 web document.

### BACKGROUND

Reflecting rapid increase of multimedia service over the Internet, the next generation web standard, HTML5 has included a standardized way to embed multimedia components on a web page by introducing two new tags, <video> and <audio> for video and audio, respectively. Both elements provide a way to include one or more source multimedia data of them. For <video> element, it is also possible to describe its spatial attributes such as width and heights.

Such new tags for audio and video does not provide a way to represent precise control of temporal behavior of multimedia components descriptively. HTML5 assumes the use of JavaScript to programmatically control temporal behavior of multimedia components. HTML5 media API allows to present user interface elements for users to control start and pause media elements. It also allows controlling the speed of playback and jumping to specific position of media data.

However, using JavaScript for control of temporal behavior of multimedia have several potential drawbacks as follows: as JavaScript engines do not guarantee real-time processing of scripts embedded in the HTML5 page, time critical control of multimedia component would not be guaranteed; as time critical temporal behavior of multimedia components and static attributes of other components of web page are mixed in one DOM tree, they cannot be separately handled so that any update to DOM tree might delay time critical update of temporal behavior of multimedia components; and as the life cycle of a script is bounded by loading of the web page embedding it, any update or refresh of HTML5 document would results resetting of the playback of multimedia components.

### SUMMARY

A method for presenting a HTML page comprises determining whether a HTML file contains a reference to a CI document, fetching and processing the CI document describing a behavior of at least one HTML element, and presenting the HTML page by decoding the HTML file, based on the CI document.

The method comprises, upon detecting an update of the CI document, re-presenting the HTML page based on the updated CI file.

The CI document includes a version for detecting the update of CI file.

The CI document include a chunk reference referring to a media chuck to be played, and a synchronization unit (SU) to control a playing time of the media chunk.

The CI document includes a plurality of SUs, each SU including respective chuck reference referring to each media chuck.

The SU is configured to provide a start time to play for each media chunk.

The SU is configured to provide respective relative time against a preceding SU for playing for each of a plurality of media chunks.

The CI document is configured to provide information on the spatial layout of the at least one HTML element.

The CI document is configured to describe change of style to at least one HTML Element, the style including at least one of a position, appearance, visibility of the at least one HTML element.

The CI document includes a chunk reference referring to a media chuck to be played, and a synchronization unit to control a playing time of the media chunk.

An apparatus for presenting a HTML page, comprising a processing circuitry configured to determine whether a HTML file contains a reference to a CI document, fetch and process the CI document describing a behavior of at least one HTML element, and present the HTML page by decoding the HTML file, based on the CI document.

An apparatus for presenting a HTML page, comprises a HTML processing unit configured to determine whether a HTML file contains a reference to a CI document, a media processing unit configured to fetch and process the CI document describing a behavior of at least one HTML element, and a presentation unit configured to presenting the HTML page by decoding the HTML file, based on the CI document.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a wireless network according to an embodiment of the present disclosure;

FIG. 2 illustrates an example Composition Information (CI) layer according to embodiments of the present disclosure;

FIG. 3 illustrates the structures of a HTML 5 file and a CI file according to embodiments of the present disclosure;

FIG. 4 illustrates the structure of a HTML 5 file and a CI file according to anther embodiment of the present disclosure;

FIG. 5 is a high-level block diagram conceptually illustrating an example media presentation system according to embodiments of the present disclosure;

FIG. 6 is a flowchart illustrating an example operation of processing the contents according to embodiments of the present disclosure;

FIG. 7 illustrates an example client device in which various embodiments of the present disclosure can be implemented;

FIG. 8 illustrates a package is a logical entity and its logical structure according to an MMT content model; and

FIG. 9 depicts an example of the timing of the presentation of a Multimedia Processing Unit (MPU) from different Assets that is provided by the Present Information (PI) document.

### DETAILED DESCRIPTION

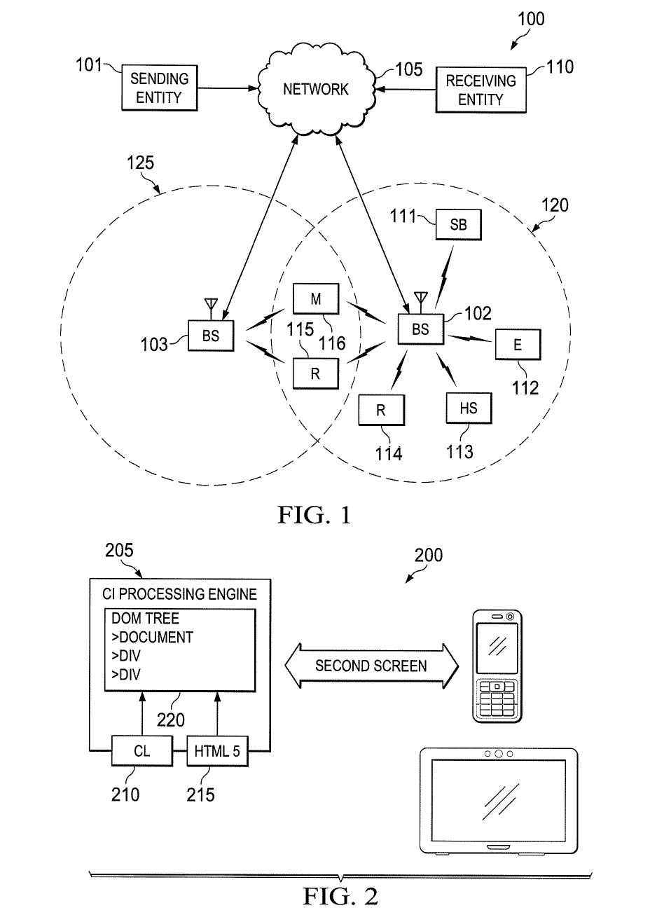

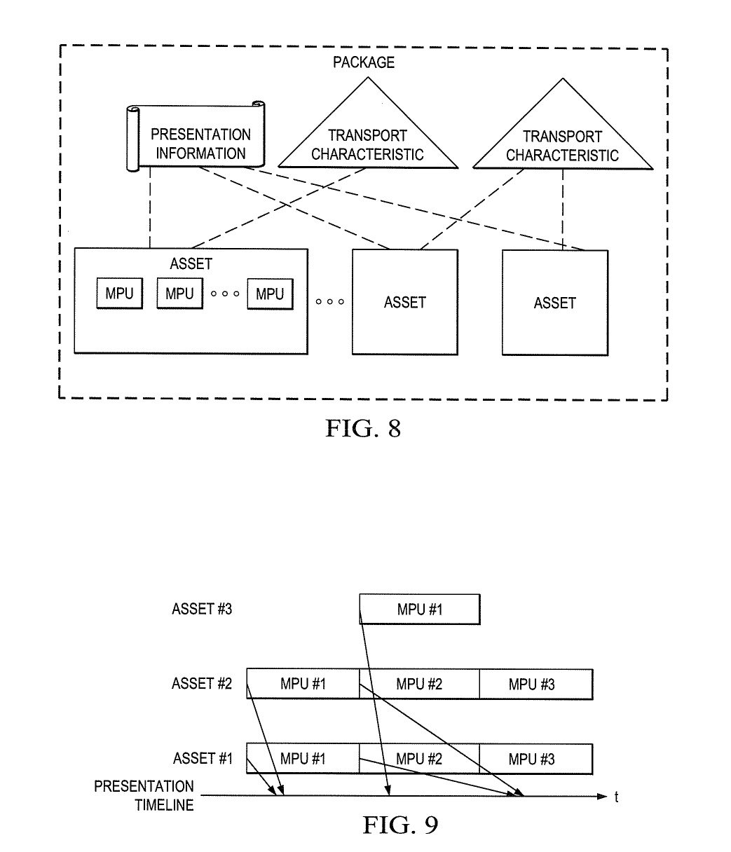

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

FIG. 1 illustrates an example of a point-to-multipoint transmission system 100 in which various embodiments of the present disclosure can be implemented. In the illustrated embodiment, the system 100 includes a sending entity 101, a network 105, receiving entities 110-116, wireless transmission points (e.g., an Evolved Node B (eNB), Node B), such as base station (BS) 102, base station (BS) 103, and other similar base stations or relay stations (not shown). Sending entity 101 is in communication with base station 102 and base station 103 via network 105 which can be, for example, the Internet, a media broadcast network, or IP-based communication system. Receiving entities 110-116 are in communication with sending entity 101 via network 105 and/or base stations 102 and 103.

Base station 102 provides wireless access to network 105 to a first plurality of receiving entities (e.g., user equipment, mobile phone, mobile station, subscriber station) within coverage area 120 of base station 102. The first plurality of receiving entities includes user equipment 111, which can be located in a small business (SB); user equipment 112, which can be located in an enterprise (E); user equipment 113, which can be located in a WiFi hotspot (HS); user equipment 114, which can be located in a first residence (R); user equipment 115, which can be located in a second residence (R); and user equipment 116, which can be a mobile device (M), such as a cell phone, a wireless communication enabled laptop, a wireless communication enabled PDA, a tablet computer, or the like.

Base station 103 provides wireless access to network 105 to a second plurality of user equipment within coverage area 125 of base station 103. The second plurality of user equipment includes user equipment 115 and user equipment 116. In an exemplary embodiment, base stations 101-103 can communicate with each other and with user equipment 111-116 using OFDM or OFDMA techniques including techniques for: presenting an HTML page as described in embodiments of the present disclosure.

While only six user equipment are depicted in FIG. 1, it is understood that system 100 can provide wireless broadband and network access to additional user equipment. It is noted that user equipment 115 and user equipment 116 are located on the edges of both coverage area 120 and coverage area 125. User equipment 115 and user equipment 116 each communicate with both base station 102 and base station 103 and can be said to be operating in handoff mode, as known to those of skill in the art.

User equipment 111-116 can access voice, data, video, video conferencing, and/or other broadband services via network 105. In an exemplary embodiment, one or more of user equipment 111-116 can be associated with an access point (AP) of a WiFi WLAN. User equipment 116 can be any of a number of mobile devices, including a wireless-enabled laptop computer, personal data assistant, notebook, handheld device, or other wireless-enabled device. User equipment 114 and 115 can be, for example, a wireless-enabled personal computer (PC), a laptop computer, a gateway, or another device.

FIG. 2 illustrates an example Composition Information (CI) layer 200 according to embodiments of the present disclosure. The embodiment shown in FIG. 4 is for illustration only. Other embodiments of CI layer could be used without departing from the scope of the present disclosure.

The CI layer 200 is designed to provide temporal behavior of multimedia components on the HTML5 web page, for example, using declarative manner. In certain embodiments, the composition information is split over two separate files: a HTML 5 file 215 and a Composition Information (CI) file 210. A compatible HTML 5 file 215 provides the initial spatial layout and the place holder media elements, and a composition information file 210 contains timed instructions to control the media presentation.

In certain embodiments, temporal behavior of multimedia components on the web page of a HTML5 file is provided by a CI file 210, where the web page can be referred by using its URI and the multimedia elements in the HTML5 file such as <video> and <audio> elements are referred by their IDs. In other words, the CI file 210 describes temporal behavior of multimedia component as a combination of temporal behavior of parts of multimedia data instead of temporal behavior of entire length of multimedia data to construct a multimedia component as a flexible combination of data from multiple data.

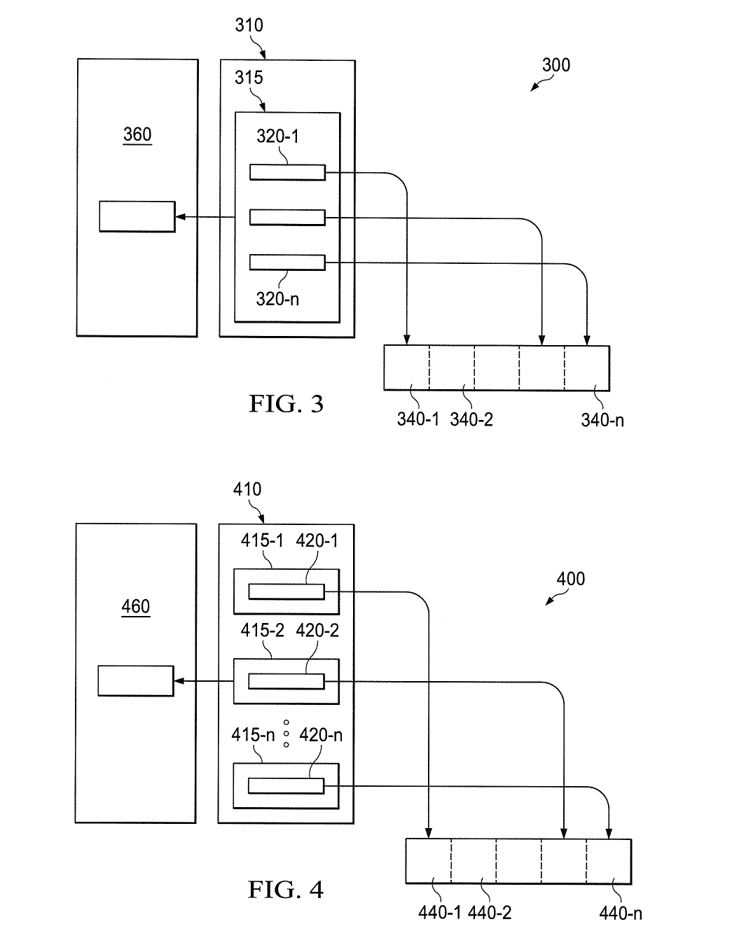

FIG. 3 illustrates the structures of a HTML 5 file 360 and a CI file 310 according to embodiments of the present disclosure. The embodiment in FIG. 3 is for illustration only. Other embodiments could be used without departing from the scope of the present disclosure.

In certain embodiments, the temporal behavior of multimedia components can be represented by defining Synchronization Unit (SU) in the CI file. The CI file 310 includes a SU 315 that contains one or more chunk information 320-1 to 320-n referring to one or more media chunks 340-1 to 340-n, respectively, which include multimedia data.

In certain embodiments adopting absolute time, the SU 315 in the CI file 310 can specify specific time, not the beginning of the chunk, as a starting point of playback by providing the beginning position of the chunks 340-1 to 340-n in time with the well-known attribute, such as clipbegin, from W3C SMIL (Synchronized Multimedia Integration Language).

In certain embodiments adopting absolute time, the SU 310 can provide the start time or end time of the chunk listed at the first by using absolute time, e.g., UTC. Also, the SU 320 can use relative time against the other SU or the event defined in the HTML5 web page, which the CI file is referring to. In other words, the start time of the first chunk 340-1 listed in the SU 310 is same with the start time of the SU 310. The start time of the chunks 340-2 to 340-n except the first one 340-1 listed in a SU is same with the end time of the preceding chunk, where the end time is given by the sum of start time and the duration. Each chunk might have some information about the start time relative to the beginning of the multimedia data they belongs but such information is not used for synchronization in an embodiment of this disclosure.

FIG. 4 illustrates the structure 400 of a HTML 5 file 460 and a CI file 410 according to anther embodiment of the present disclosure. The embodiment in FIG. 4 is for illustration only. Other embodiments could be used without departing from the scope of the present disclosure.

In the embodiment, HTML5 file 460 can have more than one multimedia components and a CI file 410 can have more than one SUs 420-1 to 420-n. In such case, two or more SUs referencing multimedia element different to each other can overlap in same time.

Alternatively, a single multimedia component on HTML5 web page 410 can be referenced by more than one SUs 420-1 to 420-n. In this embodiment, multimedia elements are presented by the chunks from more than one multimedia data. The SUs referencing same multimedia component may not overlap each other in time.

In certain embodiments, a single CI file 460 is delivered to multiple clients and some SUs can have chunk information that can be interpreted differently based on the context of each client such as a type, location, user profile, and the like. The duration of such SUs can vary based on the duration of chunks associated so that the start time of SU succeeding it might be different to each client.

In certain embodiments, a well-known data format can be used for the chunk of media data, for example Dynamic Adaptive Streaming over HTTP (DASH) segment or MPEG Media Transport (MMT), Media Processing Unit (MPU). In the case of using MMT MPU as a data format for chunk, MMT Asset ID and the sequence number of each MPU can be used as a method to reference a specific MPU as chunk information.

In certain embodiments, a well-known manifest file format such as DASH MPD (Media Presentation Description) can be used as chunk information. In the case of using DASH MPD as chunk information, the start time of the first Period listed in the DASH MPD is given by the start time of the SU, and SU can provide the starting position in time of the MPD by referring to specific Period from such MPD.

In certain embodiments, the CI file 310 provides information on the spatial layouts and appearances of the elements on the HTML webpage. Further, the CI file 310 can provide a modification instruction for the spatial layout of elements of the presentation. In the embodiments, the spatial layout can be covered by the divLayout element.

Regarding CI syntax and semantics, in certain embodiments, the composition information can be based on a XML-based format to signal the presentation events and updates to the client. In one approach, the CI information can be formatted with a declarative type of signaling, where a SMIL-similar syntax is used to indicate the playback time of a specific media element. The declarative type of signaling is also used to indicate secondary screen layout by designating certain “div” elements to be displayed in a secondary screen.

With the declarative CI Syntax, the CI file is formatted as an XML file that is similar in syntax to SMIL. This approach attempts to preserve the solution currently provided by the 2nd Committee Draft (CD) of MMT as much as possible. It extracts the HTML 5 extensions and puts them into a separate CI file. The CI file contains a sequence of view and media elements. The view element contains a list of divLocation items, which indicate the spatial position of div elements in the main HTML5 document. The list of divLocation items can as well point to a secondary screen. The media elements refer to the media elements with the same identifier in the main HTML 5 document and provide timing information for the start and end of the playout of the corresponding media element.

Alternatively, the events of a media presentation are provided as actions to change the media presentation. These actions can then be translated into JavaScript easily.

With action-based CI Syntax, the CI file is formatted as an XML file to simplify its processing at the authoring and processing sides. As discussed above, the CI applies modifications to the DOM tree generated from the HTML 5 at specific points of time.

The CI supports both relative and absolute timing. The relative timing uses the load time of the document as reference. The absolute timing refers to wall clock time and assumes that the client is timely synchronized to the UTC time, e.g. using the NTP protocol or through other means.

Timed modifications to the spatial layout and appearance of elements of the presentation are performed through the assignment of new CSS styles to that element. The playback of media elements is controlled through invoking the corresponding media playback control functions.

The XML schema for the CI file is provided in the following table:

TABLE 1
<?xml version=“1.0” encoding=“UTF-8”?>
<xs:schema xmlns:xs=“http://www.w3.org/2001/XMLSchema”
xmlns=“urn:mpeg:MMT:schema:CI:2013”
elementFormDefault=“qualified”
attributeFormDefault=“unqualified”>

<xs:annotation>

<xs:appinfo>MMT Composition Information</xs:appinfo>
<xs:documentation xml:lang=“en”>This Schema defines the
MMT

Composition Information for MMT.</xs:documentation>

</xs:annotation>
<xs:element name=“CI” type=“CItype” />
<xs:complexType name=“CItype”>

<xs:sequence>

<xs:element name=“Action” type=“ActionType”/>
<xs:any namespace=“##other” processContents=“lax”
minOccurs=“0”

maxOccurs=“unbounded”/>

</xs:sequence>
<xs:attribute name=“version” type=“xs:unsignedInt” />
<xs:attribute name=“clock” type=“ClockType” />
<xs:anyAttribute namespace=“##other” processContents=“lax”/>

</xs:complexType>
<xs:simpleType name=“ClockType”>

<xs:restriction base=“xs:string”>

<xs:enumeration value=“UTC”/>
<xs:enumeration value=“relative”/>

</xs:restriction>

</xs:simpleType>
<xs:complexType name=“ActionType”>

<xs:sequence>

<xs:element name=“ActionItem” type=“ActionItemType”/>
<xs:any namespace=“##other” processContents=“lax”
minOccurs=“0”

maxOccurs=“unbounded”/>

</xs:sequence>
<xs:attribute name=“id” type=“xs:unsignedInt” />
<xs:attribute name=“time” type=“xs:duration” />
<xs:anyAttribute namespace=“##other”
processContents=“lax”/>

</xs:complexType>
<xs:complexType name=“ActionItem”>

<xs:sequence>

<xs:any namespace=“##other” processContents=“lax”
minOccurs=“0”

maxOccurs=“unbounded”/>

</xs:sequence>
<xs:attribute name=“type” type=“ActionTypeType” />
<xs:attribute name=“target” type=“xs:string” />
<xs:attribute name=“action” type=“xs:string” />
<xs:anyAttribute namespace=“##other”
processContents=“lax”/>

</xs:complexType>
<xs:simpleType name=“ActionTypeType”>

<xs:restriction base=“xs:string”>

<xs:enumeration value=“style”/>
<xs:enumeration value=“screen”/>

```
  <xs:enumeration value=“update”/>
  <xs:enumeration value=“source”/>
```

<xs:enumeration value=“media”/>

</xs:restriction>

</xs:simpleType>

</xs:schema>

The CI consists of a set of actions that apply at specific time. The action items can be related to the media or its source, the style of an element, an update of the presentation (e.g. replacing or removing an element), or the screen.

Several action items can be bundled together for execution at the same time. Each action item specifies the target element in the DOM that it will apply the action to. For example a style action will apply the provided @style in the action string to the DOM element identified by the @target attribute. Media action items contain media functions that are to be executed on the media element identified by the @target attribute.

The semantics of the CI elements are provided in the following table:

TABLE 2

| Element or Attribute Name | Use | Description |
|---|---|---|
| CI | M | root element for the CI |
| @version | M | version of the current CI. The version field is used |
| | | to identify duplicate CI information. |
| @clock | OD | clock provides the type of the clock |
| | default: | information provided in this CI. If this |
| | relative | attribute is absent then it shall be assumed to |
| | | be relative. In this case, the time information |
| | | applies to the instant the document has been |
| | | loaded. In case it is present and has the value |
| | | “absolute”, then time indications in this CI |
| | | are in UTC time. |
| Action | 0 . . . N | An action element contains the information |
| | | about an action to be applied to the DOM. |
| @id | M | an identifier of the current action. Actions |
| | | having the same identifier are considered to |
| | | be identical, even across multiple CI files. |
| @time | M | The time at which the current action is to be |
| | | executed. |
| ActionItem | 1 . . . N | An action may consist of several action |
| | | items. |
| @type | M | The type of the current action item. It can |
| | | either be a media action, a source action, a |
| | | style action, an update action, or a screen |
| | | action. |
| @target | M | The target DOM element to which the |
| | | current action item is to be applied. |
| @action | M | A string that carries a description of the |
| | | action. The value of this string is to be |
| | | interpreted based on the type of the action. |

The following table defines the possible actions that are allowed for each action type:

TABLE 3

| Action | |
|---|---|
| Type | Possible Actions |
| media | The allowed actions are “play”, “pause”, “load” |
| source | The action attribute must hold a URI to the media source |
| | that will be set to the target element at the designated time. |
| screen | The possible actions are defined in table 2 of the 2^{nd} SoCD of |
| | MMT. |
| update | The allowed action is an element definition that replaces the |
| | target element in the DOM. If the target element identifier does |
| | not already exist, a new element will be created and appended |
| | to the DOM. |
| style | The allowed action is a string that contains one or more CSS 3 |
| | instructions. |
| | The style instructions will be applied to the target element at the |
| | designated time. |

Meanwhile, the CI will steadily require updates, especially in the case of a live service. This update can result from the need to update the media sources, the spatial layout, add or remove media elements, mark content for rendering on a secondary screen, and the like.

For this, a CI processing engine should observe for updates of the CI. This can for instance be achieved by verifying the version number of the CI file. When a new CI is detected, the instructions that it contains are extracted and scheduled for execution. In a typical implementation, the CI processing engine can be implemented as a JavaScript. The JavaScript can regularly fetch the CI file using AJAX or by reading it from a local file. Alternatively, the MMT receiver can invoke an event for the CI processing engine whenever it receives a new version of the CI file.

The following table is an example of a CI file that is authored according to the action-based format:

TABLE 4
<?xml version=“1.0” encoding=“UTF-8”?>
<CI clock=“absolute” version=“5”

xsi:schemaLocation=“urn:mpeg:MMT:schema:CI:2013 Untitled1.xsd”
xmlns=“urn:mpeg:MMT:schema:CI:2013”
xmlns:xsi=“http://www.w3.org/2001/XMLSchema-instance”>

<Action time=“P43Y4M25DT10H30M35S” id=“0”>

<ActionItem action=“complementary” type=“screen” target=“div2”/>

</Action>
<Action time=“P43Y4M25DT10H30M35.154S” id=“1”>

<ActionItem action=“http://www.example.com/asset1/mpu3.mp4” type=“source”

target=“video1”/>

<ActionItem action=“play” type=“media” target=“video1”/>

</Action>
<Action time=“P43Y4M25DT10H30M36S” id=“2”>

<ActionItem action=“ ” type=“update” target=“div3”/>

</Action>
<Action time=“P43Y4M25DT10H30M45S” id=“3”>

<ActionItem action=“top=50px; left=100px;” type=“style” target=“div1”/>

</Action>

</CI>

In this example, several actions are indicated. The first action signals that a “div” element with id “div2” is suggested to be displayed on a secondary screen only. As such, it will be hidden from the primary screen. The second action contains 2 action items. The first action item sets the source of a video element. The second item starts the playback of that video item at the indicated action time. The third action is an update action that completely removes the element with id “div3” from the DOM. The last action is a style action. It sets the position of the target element “div1” to (50,100) pixels.

For harmonization with Media Presentation Description (MPD), as part of the ongoing discussion between the MPEG MMT and (Dynamic Adaptive Streaming over HTTP) DASH adhoc groups, an effort to harmonize between DASH and MMT is being discussed extensively. DASH is based on the MPD, which acts as a manifest file that describes possible ways to access the content and the related timing. However, the MPD does not offer the advanced features of a media presentation. For example, it does not offer the tools to control the layout of the media presentation. The MPD was also designed with the delivery and presentation needs of a single piece of content (including all its media components) in mind. It is not currently possible to provide different pieces of content with overlapping timelines or dependent timelines as part of a single MPD. As a consequence, several use cases of ad insertion may not be realized using the MPD only.

Alternatively, the CI layer of MMT aims at addressing similar use cases. It does so by inheriting the capabilities of HTML 5 for supporting multiple media elements simultaneously and adding the CI file, which defines the dynamics of the media presentation. By enabling the addressing of an MPD from the CI information, a media presentation can make use of DASH delivery easily. This can for example be achieved by setting the source of a media element to point to an MPD file.

Due to the harmonization at the segment/presentation layer, pointing to an MPD can facilitate the media consumption as the set of MPUs to be processed would be provided by the MPD (as part of a set of consecutive Periods, each Period pointing to one or more MPUs as Representations).

Using the CI file also allows providing multiple and time overlapping pieces of content. This is achieved by mapping multiple media elements in HTML 5 to multiple MPD files. Each media element will be assigned a playout starting time that determines when the first media segment of the first Period of the MPD is to be played out. The following table is an example of a CI that references 2 MPDs and uses the SMIL-similar syntax:

TABLE 5
<html>

<body>

<video id=”video1” src=”content1.mpd” begin=”0”
end=”100”/>
<video id=”video2” src=”advert1.mpd” begin=”20” end=”25”/>

</body>

</html>

The same example can look as the following table using the action-based CI format:

TABLE 6
<?xml version=“1.0” encoding=“UTF-8”?>
<CI clock=“absolute” version=“5”

xsi:schemaLocation=“urn:mpeg:MMT:schema:CI:2013
Untitled1.xsd”
xmlns=“urn:mpeg:MMT:schema:CI:2013”
xmlns:xsi=“http://www.w3.org/2001/XMLSchema-instance”>

<Action time=“POS” id=“1”>

<ActionItem action=“content1.mpd” type=“source”
target=“video1”/>
<ActionItem action=“play” type=“media” target=“video1”/>

</Action>
<Action time=“P20S” id=“1”>

<ActionItem action=“advert1.mpd” type=“source”
target=“video2”/>
<ActionItem action=“play” type=“media” target=“video2”/>

</Action>

</CI>

Note that the presentation time instructions overwrite the time presentation time hints given by the MPD (e.g. the availabilityStartTime+suggestedPresentationDelay).

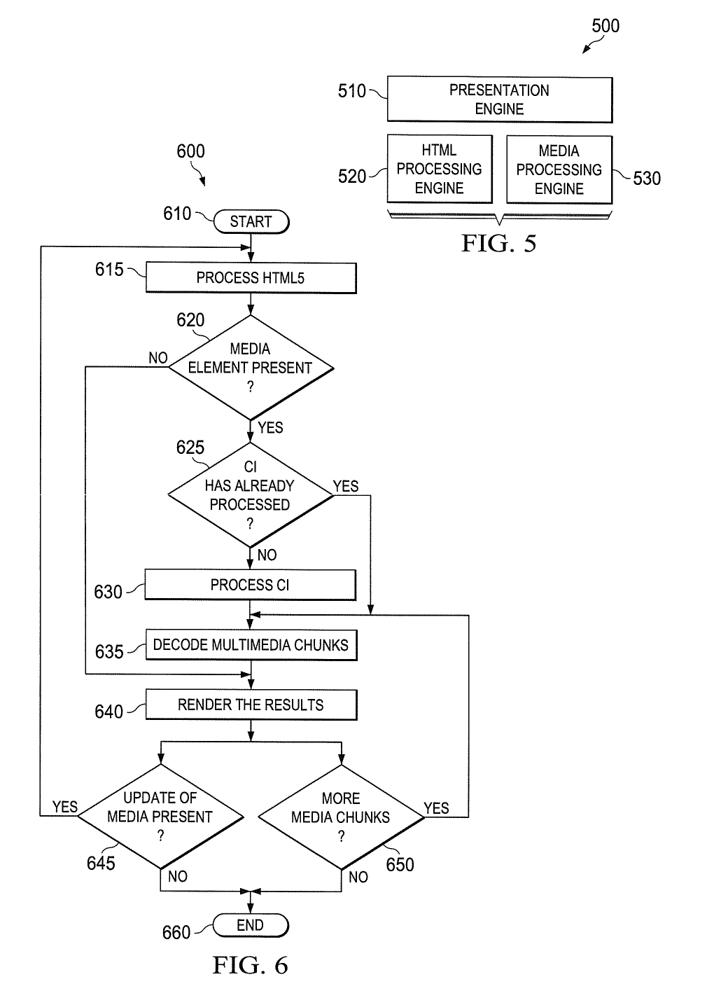

FIG. 5 is a high-level block diagram conceptually illustrating an example media presentation system 500 according to embodiments of the present disclosure. The embodiment in FIG. 5 is for illustration only. Other embodiments of media presentation system could be used without departing from the scope of the present disclosure.

The system include a presentation engine 510 at the upper level, and a HTML processing engine 520 and a media processing engine 530 at the lower level. The HTML5 engine 520 processes HTML5 web page and the media processing engine 530 processes the CI file and the chunks listed in it. The presentation engine 510 merges the result of the media processing engine 530 with the result of HTML processing engine 510 and renders it together.

More particularly, the HTML5 engine 520 parses the HTML 5 file into a Document Object Model (DOM) tree and stores in memory.

The media processing engine 530 fetches the CI and the HTML5 files (and any other referenced files) and processes the CI information to control the presentation accordingly.

HTML processing engine 520 and media processing engine 530 can update their results at different time. In some examples, media processing engine 530 can continuously update the decoded media data while HTML processing engine 520 is parsing HTML5 file and constructing rendering tree. For updating CI, the media processing engine 530 applies changes to the DOM at specified time according to the instructions that are available in the CI file. The DOM nodes/elements are referenced using their identifiers or possibly using a certain patterns (e.g. provided through jQuery selectors).

FIG. 6 is a flowchart 600 illustrating an example operation of processing the contents according to embodiments of the present disclosure. While the flowchart depicts a series of sequential steps, unless explicitly stated, no inference should be drawn from that sequence regarding specific order of performance, performance of steps or portions thereof serially rather than concurrently or in an overlapping manner, or performance of the steps depicted exclusively without the occurrence of intervening or intermediate steps. The operation depicted in the example depicted is implemented by processing circuitry in a UE.

The processing operation 600 starts in operation 610. In operation 615, the client device processes a HTML5 web page and evaluates if there is media elements. If there is no media element, then it goes to the operation of rendering the processed results of HTML5. Here, the client device can by any suitable device being able to communicate with a server, including a mobile device and a personal computer.

If there is any media element in operation 620, then the client device first evaluates whether the same CI file is already in process in operation 625. If it is already in process then, it goes to operation 635 of decoding multimedia chunks. If not, then it process CI file in operation 630.

After processing CI file in operation 630, multimedia chunk listed in the CI file is processed in operation 535 then the results are rendered in operation 640. Such operations can be repeated until there is no more multimedia chunks need to be processed exists. If there is any update of HTML5 exists in operation 645, the client device processes it in parallel with the process of multimedia chunks at any time during the decoding and rendering of the chunk under processing.

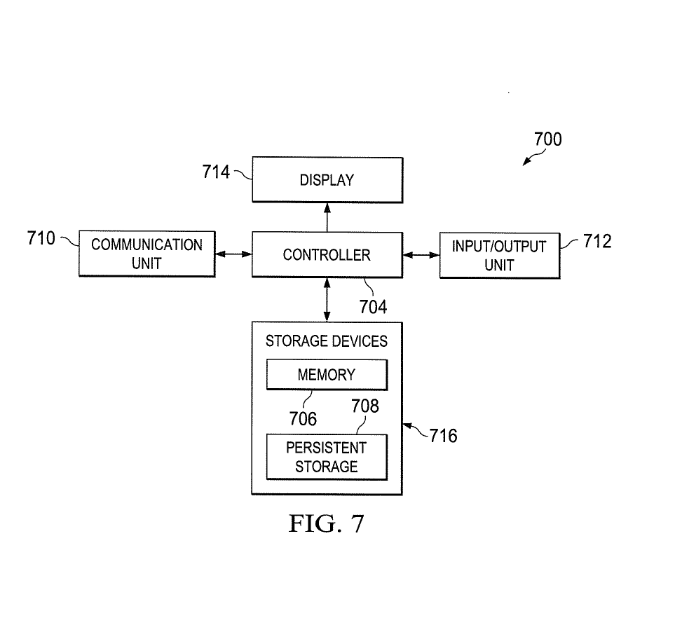

FIG. 7 illustrates an example client device 700 in which various embodiments of the present disclosure can be implemented. In this example, the client device 700 includes a controller 704, a memory 706, a persistent storage 708, a communication unit 710, an input/output (I/O) unit 712, and a display 714. In these illustrative examples, client device 700 is an example of one implementation of the sending entity 101 and/or the receiving entities 110-116 in FIG. 1.

Controller 704 is any device, system, or part thereof that controls at least one operation. Such a device can be implemented in hardware, firmware, or software, or some combination of at least two of the same. For example, the controller 704 can include a hardware processing unit and/or software program configured to control operations of the client device 700. For example, controller 704 processes instructions for software that can be loaded into memory 706. Controller 704 can include a number of processors, a multi-processor core, or some other type of processor, depending on the particular implementation. Further, controller 704 can be implemented using a number of heterogeneous processor systems in which a main processor is present with secondary processors on a single chip. As another illustrative example, controller 704 can include a symmetric multi-processor system containing multiple processors of the same type.

Memory 706 and persistent storage 708 are examples of storage devices 716. A storage device is any piece of hardware that is capable of storing information, such as, for example, without limitation, data, program code in functional form, and/or other suitable information either on a temporary basis and/or a permanent basis. Memory 706, in these examples, can be, for example, a random access memory or any other suitable volatile or non-volatile storage device. For example, persistent storage 708 can contain one or more components or devices. Persistent storage 708 can be a hard drive, a flash memory, an optical disk, or some combination of the above. The media used by persistent storage 708 also can be removable. For example, a removable hard drive can be used for persistent storage 708.

Communication unit 710 provides for communications with other data processing systems or devices. In these examples, communication unit 710 can include a wireless (cellular, WiFi, etc.) transmitter, receiver and/or transmitter, a network interface card, and/or any other suitable hardware for sending and/or receiving communications over a physical or wireless communications medium. Communication unit 710 can provide communications through the use of either or both physical and wireless communications links.

Input/output unit 712 allows for input and output of data with other devices that can be connected to or a part of the client device 700. For example, input/output unit 712 can include a touch panel to receive touch user inputs, a microphone to receive audio inputs, a speaker to provide audio outputs, and/or a motor to provide haptic outputs. Input/output unit 712 is one example of a user interface for providing and delivering media data (e.g., audio data) to a user of the client device 700. In another example, input/output unit 712 can provide a connection for user input through a keyboard, a mouse, external speaker, external microphone, and/or some other suitable input/output device. Further, input/output unit 712 can send output to a printer. Display 714 provides a mechanism to display information to a user and is one example of a user interface for providing and delivering media data (e.g., image and/or video data) to a user of the client device 700.

Program code for an operating system, disclosures, or other programs can be located in storage devices 716, which are in communication with the controller 704. In some embodiments, the program code is in a functional form on the persistent storage 708. These instructions can be loaded into memory 706 for processing by controller 704. The processes of the different embodiments can be performed by controller 704 using computer-implemented instructions, which can be located in memory 706. For example, controller 704 can perform processes for one or more of the modules and/or devices described above.

FIG. 8 illustrates an MMT content model according to embodiments of the present disclosure. It should be noted that the CI file is applicable to any format of presentation and media files. The embodiment in FIG. 8 is for illustration only. Other embodiments of the MMT content model could be used without departing from the scope of the present disclosure.

A package is a logical entity and its logical structure in the MMT content model as illustrated in FIG. 8. Hereinafter, the logical structure of Package as a collection of encoded media data and associated information for delivery and consumption purposes will be defined.

Firstly, a Package shall contain one or more presentation information documents such as one specified in Part 11 of the MMT standard, one or more Assets that may have associated transport characteristics. An Asset is a collection of one or more media processing units (MPUs) that share the same Asset ID. An Asset contains encoded media data such as audio or video, or a web page. Media data can be either timed or non-timed.

Presentation Information (PI) documents specify the spatial and temporal relationship among the Assets for consumption. The combination of HTML5 and Composition Information (CI) documents specified in part 11 of this standard are an example of PI documents. A PI document may also be used to determine the delivery order of Assets in a Package. A PI document shall be delivered either as one or more messages defined in this specification or as a complete document by some means that is not specified in this specification. In the case of broadcast delivery, service providers may decide to carousel presentation information documents and determine the frequency at which carouseling is to be performed.

Secondly, an asset is any multimedia data to be used for building a multimedia presentation. An Asset is a logical grouping of MPUs that share the same Asset ID for carrying encoded media data. Encoded media data of an Asset can be either timed data or non-timed data. Timed data are encoded media data that has an inherent timeline and may require synchronized decoding and presentation of the data units at a designated time. Non-timed data is other types of data that can be decoded at an arbitrary time based on the context of a service or indications from the user.

MPUs of a single Asset shall have either timed or non-timed media. Two MPUs of the same Asset carrying timed media data shall have no overlap in their presentation time. In the absence of a presentation indication, MPUs of the same Asset may be played back sequentially according to their sequence numbers.

Any type of media data which can be individually consumed by the presentation engine of an MMT receiving entity is considered as an individual Asset. Examples of media data types which can be considered as an individual Asset are Audio, Video, or a Web Page.

In some embodiments, various functions described above are implemented or supported by a computer program product that is formed from computer-readable program code and that is embodied in a computer-readable medium. Program code for the computer program product can be located in a functional form on a computer-readable storage device that is selectively removable and can be loaded onto or transferred to client device 700 for processing by controller 704. In some illustrative embodiments, the program code can be downloaded over a network to persistent storage 708 from another device or data processing system for use within client device 700. For instance, program code stored in a computer-readable storage medium in a server data processing system can be downloaded over a network from the server to client device 700. The data processing system providing program code can be a server computer, a client computer, or some other device capable of storing and transmitting program code.

The embodiments according to the present disclosure provide solutions base for the CI function in MMT. The embodiments would resolve the concerns about HTML 5 extensions and would provide a flexible framework that gives a lot of freedom to implementers to use appropriate technologies (i.e. it can be implemented based on JavaScript or natively).

Although the present disclosure has been described with an exemplary embodiment, various changes and modifications can be suggested to one skilled in the art. It is intended that the present disclosure encompass such changes and modifications as fall within the scope of the appended claims.

What is claimed is:

1. A method for presenting a hypertext markup language (HTML) page, comprising:
determining whether a HTML file contains a reference to a CI document;
fetching and processing the CI document describing a behavior of at least one HTML element;
presenting the HTML page by decoding the HTML file, based on the CI document.

2. The method of claim 1, further comprising:
upon detecting an update of the CI document, re-presenting the HTML page based on the updated CI file.

3. The method of claim 2, wherein the CI document includes a version for detecting the update of CI file.

4. The method of claim 1, wherein the CI document include a chunk reference referring to a media chuck to be played, and a synchronization unit (SU) to control a playing time of the media chunk.

5. The method of claim 4, wherein the CI document includes a plurality of SUs, each SU including respective chuck reference referring to each media chuck.

6. The method of claim 4, wherein the SU is configured to provide a start time to play for each media chunk.

7. The method of claim 4, wherein the SU is configured to provide respective relative time against a preceding SU for playing for each of a plurality of media chunks.

8. The method of claim 4, wherein the CI document is configured to provide information on the spatial layout of the at least one HTML element.

9. The method of claim 8, wherein the CI document is configured to describe change of style to at least one HTML Element, the style including at least one of: a position, appearance, visibility of the at least one HTML element.

10. The method of claim 1, wherein the CI document includes a chunk reference referring to a media chuck to be played, and a synchronization unit to control a playing time of the media chunk.

11. An apparatus for presenting a HTML page, comprising a processing circuitry configured to:
determine whether a HTML file contains a reference to a CI document;
fetch and process the CI document describing a behavior of at least one HTML element; and
present the HTML page by decoding the HTML file, based on the CI document.

12. The apparatus of claim 11, the processing circuitry further configured to:
upon detecting an update of the CI document, re-present the HTML page based on the updated CI file.

13. The apparatus of claim 11, wherein the CI document includes a version for detecting the update of CI file.

14. The apparatus of claim 11, wherein the CI document include a chunk reference referring to a media chuck to be played, and a synchronization unit (SU) to control a playing time of the media chunk.

15. The apparatus of claim 11, wherein the CI document includes a plurality of SUs, each SU including respective chuck reference referring to each media chuck.

16. The apparatus of claim 11, wherein the SU is configured to provide a start time to play for each media chunk.

17. The apparatus of claim 11, wherein the SU is configured to provide respective relative time against a preceding SU for playing for each of a plurality of media chunks.

18. The apparatus of claim 11, wherein the CI document is configured to provide information on the spatial layout of the at least one HTML element.

19. The apparatus of claim 11, further comprising the CI document is configured to describe change of style to at least one HTML Element, the style including at least one of: a position, appearance, visibility of the at least one HTML element:

20. An apparatus for presenting a HTML page, comprising:
a HTML processing unit configured to determine whether a HTML file contains a reference to a CI document;
a media processing unit configured to fetch and process the CI document describing a behavior of at least one HTML element; and
a presentation unit configured to presenting the HTML page by decoding the HTML file, based on the CI document.
